(19) United States
(12) Patent Application Publication
(10) Pub. No.: US 2025/0122091 A1
(43) Pub. Date: Apr. 17, 2025

(54) METHOD FOR PURIFYING ANTIMONY CHLORIDE SOLUTION THROUGH ARSENIC REMOVAL

(71) Applicant: ZHEJIANG UNIVERSITY OF TECHNOLOGY, Zhejiang (CN)

(72) Inventors: Guoqu ZHENG, Zhejiang (CN); Junfeng KONG, Zhejiang (CN); Huazhen CAO, Zhejiang (CN); Wenyu FENG, Zhejiang (CN); Huibin ZHANG, Zhejiang (CN)

(73) Assignee: ZHEJIANG UNIVERSITY OF TECHNOLOGY, Zhejiang (CN)

(21) Appl. No.: 18/953,013

(22) Filed: Nov. 19, 2024

Related U.S. Application Data
(63) Continuation of application No. PCT/CN2024/097237, filed on Jun. 4, 2024.

(30) Foreign Application Priority Data
Oct. 17, 2023 (CN) 202311339451.3

(51) Int. Cl. C01G 30/00; B01D 3/14

(52) U.S. Cl. CPC C01G 30/007; B01D 3/143; C01P 2002/72; C01P 2002/85; C01P 2004/03; C01P 2006/80

(57) ABSTRACT

The present disclosure belongs to the technical field of purification, and particularly relates to a method for purifying an antimony chloride solution through arsenic removal. The method includes: 1) adding copper-antimony alloy into a crude arsenic-containing antimony chloride solution to be treated in a protective atmosphere to obtain an antimony chloride solution containing low-concentration arsenic impurities after a reaction; and 2) performing distillation and concentration on the antimony chloride solution containing low-concentration arsenic impurities to obtain a high-purity antimony chloride solution. According to the present disclosure, the technical difficulty of removing impurity arsenic in a preparation process for high-purity antimony is solved, distillation is carried out under the condition of a low temperature, the operation is simple and low in energy consumption, and the technological process for preparation is simple, high in production efficiency, easy to realize, free of industrial pollution and therefore, suitable for industrialization.

### CROSS-REFERENCE TO RELATED APPLICATION

This application is a continuation of international application of PCT application serial no. PCT/CN2024/097237, filed on Jun. 4, 2024, which claims the priority benefit of China application no. 202311339451.3, filed on Oct. 17, 2023. The entirety of each of the above-mentioned patent applications is hereby incorporated by reference herein and made a part of this specification.

### BACKGROUND OF THE INVENTION

### 1. Technical Field

The present disclosure belongs to the technical field of purification, and particularly relates to a method for purifying an antimony chloride solution through arsenic removal.

### 2. Background Art

Antimony is an indispensable raw material for modern industrial production, is widely used in the production of various flame retardant materials, alloys, glass, semiconductor components, medical medicine, chemical industry, national defense military industry, and other fields, and plays an extremely important role in ensuring the sustainable development of the national economy and plays an irreplaceable strategic role in the development of China's industry. In recent years, with the rapid development of high-tech fields such as semiconductor manufacturing in China, the related research of high-purity antimony has attracted great attention in China. Antimony compound semiconductors produced from the high-purity antimony have good semiconductor properties, chemical bonds are mainly covalent bonds and include ionic bonds to form mixed bonds, which makes a selection range of basic parameters (band gap and carrier) wider and greatly improves physical and chemical properties of semiconductor devices. For example, Zhang Sheng-li, Zhou Wen-han, Ma Yan-dong, et al. Antimonene Oxides: Emerging Tunable Direct Bandgap Semiconductor and Novel Topological Insulator [J]. Nano Letters, 2017, 17 (6): 3434-3440 describes antimonene oxides as emerging tunable direct bandgap semiconductors, which cover a wide range of 0 to 2.28 eV, and have great potential in solar cells and photovoltaic detector applications.

At present, the main methods for preparing high-purity antimony in China are a chlorination distillation method, an electrolysis method and a vacuum distillation method. However, there are a lot of defects in the process for high-purity antimony production.

The chlorination distillation method makes use of the difference of boiling point temperatures of chlorides to separate low boiling point impurities from a main phase of antimony trichloride, thus achieving a purification effect. However, the existence form of impurities in hydrochloric acid medium is very complex, removal efficiency of impurity arsenic is low in the distillation process, and the residual arsenic content is still 50-500 ppm. The arsenic content in prepared high-purity metal antimony is difficult to control accurately.

In the invention patent application having the publication No. CN104313643A and published on Jan. 28, 2015 by the China Patent Office, a method for producing high-purity antimony by a two-stage molten salt electrolysis method is disclosed. The method includes the following steps: adding crushed antimony blocks and molten salt electrolyte into an electrolytic cell, where the electrolytic cell is provided with a first graphite electrode and a second graphite electrode; firstly, performing electrolysis by an anode method, setting the first electrode as an anode, setting the second electrode as a cathode, where in an anode region, antimony and impurity metal lose electrons to become positive ions, enter molten salt, migrate to a surface of the cathode to obtain electrons under the action of an electric field and diffusion, and remove impurity metal Na, K, Zn, Cd, Fe, Pb, Sn, Cu and Ni whose standard electrode potential is smaller than antimony; and then, performing electrolysis by employing a cathode method, setting the first electrode as a cathode, setting the second electrode as an anode, and removing non-metallic impurity elements As, S and Bi by taking reduced elementary antimony as the cathode. However, the disclosed technical solution has the problem that reduction potentials of As(III) and Sb(III) at the cathode are close, and both of them are deposited at the cathode simultaneously during electrolysis. An impurity control effect in the prepared high-purity antimony is not ideal.

Preparation of high-purity antimony metal through vacuum distillation uses an industrial pure antimony ingot (2N) as a raw material, in which the arsenic content is 100 ppm-1000 ppm. In the process of vacuum distillation, arsenic is dissolved in an antimony matrix to form an arsenic-antimony alloy phase, which makes saturated vapor pressure significantly lower, resulting in difficulty in removing arsenic from the antimony ingot rapidly through the vacuum distillation. This process needs to be repeated multiple times to achieve the effect of deep arsenic removal. In addition, separation coefficients of arsenic and antimony are similar, and it is also difficult to purify them rapidly through regional smelting.

Research on preparation of high-purity antimony in China starts late and is weak compared with European and American countries in technology. In order to narrow the gap and improve the independent research and development level of high-purity antimony, China has increased its support for high-purity antimony research in recent years. The newly issued national standard for high-purity antimony (GB/T 10117-2021) has re-standardized the content standards of arsenic, lead and tin in high-purity antimony, especially the impurity arsenic that has a great impact on the purity of high-purity antimony in actual production. The newly published national standard reduces the impurity arsenic content in 6N high-purity antimony from 0.3 ppm to 0.1 ppm, which brings great challenge to an existing production process for high-purity antimony in China. Therefore, a new technology for preparing high-purity SbCl₃ by removing arsenic from crude antimony chloride is studied so as to promote the scale and standardization of high-purity antimony production with 6N and above, which is also of strategic significance to national development layout of the semiconductor industry.

### SUMMARY OF THE INVENTION

Aiming at the technical problem that the purity of antimony metal is not up to standard due to arsenic inclusion in the prior high-purity antimony production process, the present disclosure provides a method for purifying an antimony chloride solution through arsenic removal.

Objectives of the present disclosure are:
1. Preparation of a high-purity antimony chloride solution can be realized simply and effectively.
2. High-purity antimony trichloride with purity above 3N can be obtained rapidly and effectively.
3. Ultrahigh-purity antimony trichloride with purity of 5N and above can be obtained through refining treatment.

In order to achieve the above objectives, the present disclosure employs the following technical solutions:

A method for purifying an antimony chloride solution through arsenic removal is provided.

The method includes:
1) adding copper-antimony alloy into a crude arsenic-containing antimony chloride solution to be treated in a protective atmosphere to obtain an antimony chloride solution containing low-concentration arsenic impurities after a reaction; and
2) performing distillation and concentration on the antimony chloride solution containing low-concentration arsenic impurities to obtain a high-purity antimony chloride solution.

Preferably, the protective atmosphere in step 1) is a nitrogen atmosphere, and nitrogen is continuously introduced into the solution system during the reaction process in step 1).

Preferably, a reaction temperature in step 1) is controlled to be 30-90° C.

Stirring is performed in the reaction process, a stirring rotation speed is controlled to be 100-500 rpm, and reaction time is 30-120 min.

Preferably, a stoichiometric ratio of a copper content in the copper-antimony alloy to an arsenic content in the crude arsenic-containing antimony chloride solution to be treated in step 1) is (10-40):1.

Preferably, a distillation temperature for the distillation and concentration in step 2) is controlled to be 160-180° C.

Preferably, a distilled gas sample obtained in the distillation and concentration process makes contact with a heat source, a temperature of the heat source is controlled to be ≥250° C., and distillation is terminated when the distilled gas sample makes contact with the heat source without producing an arsenic mirror.

Preferably, the high-purity antimony chloride solution obtained after the distillation and concentration in step 2) is subjected to secondary distillation and condensation to obtain high-purity antimony chloride.

Preferably, a distillation temperature for the secondary distillation is controlled to be 220-240° C.

Preferably, two-stage recovery is carried out in the condensation process, firstly, recovering is performed at 160-180° C. to obtain liquid antimony chloride, and then, the liquid antimony chloride is cooled to a recovery temperature of ≤70° C., thereby obtaining high-purity antimony chloride.

Unless otherwise specified, antimony chloride in the present disclosure is antimony trichloride (SbCl₃).

For the present disclosure, the core lies in constructing a galvanic cell system in the crude solution system. In the present disclosure, the copper-antimony alloy is specially selected, and an antimony content in the alloy needs to be ensured to be 5-30 wt %. Since in the antimony chloride solution, when arsenic exists in the form of AsO⁺, an alloy phase region and a copper-rich region in the copper-antimony alloy can form a galvanic cell structure due to a potential difference, where the copper-antimony phase microregion in alloy powder is negatively charged, and selective adsorption of arsenic ions in the solution can be promoted. In order to avoid side reactions, the purity of the copper-antimony alloy also needs to reach 2N (99.0%) and above. The copper-antimony alloy powder is an intermetallic compound, and a potential thereof changes. Compared with pure copper powder, antimony element doping can effectively reduce loss of Sb³⁺ in the solution. The purity of the introduced copper-antimony alloy powder is 2N or more, which can avoid introducing excessive impurity elements. Moreover, antimony in the copper-antimony alloy plays a crucial role in stable capture of As elements. When the antimony content is too small, As can not be stably captured and removed, and the potential difference can not be effectively formed, while when the antimony content is too large, the galvanic effect of copper will be reduced, reaction efficiency is low, and removal is not complete. Similarly, it is necessary to control a stoichiometric ratio of the copper content in the copper-antimony alloy to the arsenic content in the crude arsenic-containing antimony chloride solution to be treated. In the present disclosure, the stoichiometric ratio is that the copper-antimony alloy needs to provide 1.0 mol of copper for each mol of arsenic elements contained in the crude antimony chloride solution. If the stoichiometric ratio is too small, the reaction will be incomplete and the efficiency will be low. If the stoichiometric ratio is too high, loss of antimony elements in the crude antimony chloride solution will be increased, and side reactions will be likely to be initiated.

In addition, the optimum mesh number of the copper-antimony alloy powder should be selected from 100 to 800 meshes, if the powder is too fine, the alloy powder will float in an upper layer, and a replacement reaction fails to be fully performed. If the powder is too coarse, the powder will sink to the bottom, an arsenic removal effect of the upper layer solution will be not good, and the replacement reaction fails to be fully performed. Therefore, the above particle size range of the powder is the optimal range.

Due to introduction of the copper-antimony alloy, the copper-antimony galvanic cell system can be formed in the crude antimony chloride solution to be treated in combination with AsO⁺. After the copper-antimony alloy is added into the solution, copper is used as an anode of a galvanic cell, antimony is used as a cathode, and electrons are given in the process of copper oxidation. Negative electrostatic fields are formed on the surfaces of alloy particles, and AsO⁺ is selectively adsorbed. Reaction conditions are controlled in the process to accelerate the arsenic removal process, and the replacement reaction process is more sufficient, such that the purpose of completely removing arsenic is achieved.

Specifically, the following reactions are included:

### Anodic Reaction:

Cu+Cl⁻=CuCl+e⁻

### Cathodic Reaction:

SbCl₅²⁻+3e⁻=Sb+5Cl⁻

AsO⁺+2H⁺+3e⁻=As+H₂O

### Alloying Side Reactions:

Sb+2Cu=Cu₂Sb

2As+5Cu=As₂Cu₅

In the above reaction process, it can be clearly seen that after the formation of the galvanic cell system, the copper is converted into cupric chloride to generate loss, and at the same time, elementary antimony and elementary arsenic are formed on the surface of the copper-antimony alloy. The two elements and the copper on the copper-antimony alloy generate an alloying side reaction to achieve fixation of the arsenic and the antimony, thereby reducing impurity interference, and improving the purity of the antimony chloride obtained subsequently. That is to say, a process similar to replacement is actually formed, in which the copper in the copper-antimony alloy replaces the arsenic and the antimony in the crude solution. The antimony in the copper-antimony alloy can effectively inhibit the reduction loss of the antimony in the solution, and the antimony can realize a spontaneous termination reaction to a certain extent, and avoid falling of the formed elementary antimony because the antimony is easier to produce stable combination in the alloy phase region, and realizes spreading growth to a certain extent to be coated on an outer side of a copper-arsenic alloy phase for fixation.

To achieve the above process, besides selection and control of copper-antimony alloy materials, it is also necessary to control the solution system to a certain extent. For example, when a common antimony chloride crude solution is purified, a concentration of hydrogen chloride is extremely high, and since low-concentration hydrogen chloride cannot inhibit hydrolysis of antimony trichloride, and the high-concentration hydrogen chloride is needed to inhibit the hydrolysis. The concentration is even up to 3 M above, but the existence form of arsenic is different under different concentrations of hydrogen chloride. In the present disclosure, the concentration of hydrogen chloride in the crude antimony chloride solution needs to be controlled within the range of 3-8 mol/L to ensure that the arsenic exists in the form of AsO⁺, which is conductive to the galvanic cell reaction, and the higher hydrochloric acid concentration is conductive to distillation removal of residual arsenic. In addition, the above high hydrochloric acid concentration condition is a high reducing environment, the copper at this time will only give an electron in combination with the formed galvanic cell system. From the potential point of view, the potential of formed Cu⁺ is about −1 V, the potential of the formed Cu²⁺ is 0.34 V, and the potential of arsenic is only about 0.24 V, such that the above hydrogen chloride concentration can effectively achieve arsenic removal in combination with the galvanic cell system, otherwise a reverse effect of “copper removal by arsenic” may occur.

In addition, in the reaction process of step 1) of the technical solution of the present disclosure, it is necessary to carry out the reaction in a closed protective atmosphere, and continuously introduce nitrogen into the solution system, which is because trace amounts of toxic gases such as AsH³ and SbH³ may be generated during the replacement process, and introducing the nitrogen can bring the toxic gases into a tail gas absorption device. Additionally, oxidation of the arsenic and the antimony can be avoided through nitrogen replacement in the closed environment. Once the arsenic and antimony become pentavalent arsenate, the difficulty of removal will be increased. Similarly, since the nitrogen can reduce a concentration of arsenic hydride, the above phenomenon can also be used as characterization parameters of the distillation and concentration process in the subsequent step 2), but there will still be a small amount of residues which generate intermolecular binding with residual arsenic compounds, which will be removed in the distillation and concentration process. In this process, the distilled gas is characterized to verify whether the arsenic compounds are completely removed, so as to avoid loss caused by precipitation of antimony chloride crystals on the surface of the copper-antimony alloy due to excessive distillation and concentration. In the reaction process, it is necessary to control the temperature, the stirring rotation speed and the reaction time. The too low reaction temperature will reduce the replacement efficiency, while the too high reaction temperature will lead to volatilization of hydrochloric acid and water, which destroys the hydrochloric acid concentration control in the replacement process. If the stirring rotation speed is low, the copper-antimony alloy powder and the solution fail to be in full contact, which affects the replacement efficiency. If the stirring rotation speed is too high, the solution is likely to splash in the replacement reaction, which is inconvenient to operate. If the replacement time is too short, the replacement reaction will be insufficient, affecting the arsenic removal efficiency, while if the replacement time is too long, the production cycle will be affected.

For the high-purity antimony chloride solution obtained after concentration, antimony chloride with solid impurity removal through filtration actually has relatively high purity, but further purification should be preferably performed. During the purification process, antimony trichloride is evaporated at 220-240° C. and then condensed, which can reduce high boiling point impurities, but direct condensation also has certain defects. Since the arsenic mirror test actually has a certain detection limit, when the arsenic content is extremely low, it is difficult to detect, but in fact, the purity of 3N can only be stably achieved at this time because the intermolecular force will cause that part of the arsenic is difficult to be effectively removed all the time. However, the present disclosure further employs a two-stage cold condensation recovery mode, which can further separate and remove arsenic compounds, such that the purity of the product can stably reach over 5N.

The present disclosure has the beneficial effects as follows:
1) The technical difficulty of removing impurity arsenic in the preparation process for high-purity antimony is solved.
2) Distillation is carried out under the condition of a low temperature, and the operation is simple and low in energy consumption.
3) The technological process for preparation is simple, high in production efficiency, easy to realize, free of industrial pollution and therefore, suitable for industrialization.

### BRIEF DESCRIPTION OF THE DRAWINGS

FIG. 1 shows X-ray diffraction (XRD) characterization results of a solid product (filter cake) obtained through filtration and separation in Example 1 of the present disclosure.

FIG. 2 shows XRD characterization results of a product in Example 2 of the present disclosure.

FIG. 3 shows scanning electron microscopy (SEM) characterization results of products in examples of the present disclosure, where (a) of FIG. 3 corresponds to the product of Example 1, and (b) of FIG. 3 corresponds to the product of Example 3.

FIG. 4 shows energy disperse spectroscopy (EDS) characterization results of a product in Example 3 of the present disclosure.

### DETAILED DESCRIPTION OF THE EMBODIMENTS

The present disclosure will be further clearly described in detail in combination with the particular examples and the accompanying drawings and the description. Those of ordinary skill in the art will be able to implement the present disclosure on the basis of these descriptions.

Additionally, the examples involved in the following descriptions are usually only some examples rather than all examples of the present disclosure. Therefore, on the basis of the examples of the present disclosure, all other examples obtained by those of ordinary skill in the art without making inventive efforts should all fall within the scope of protection of the present disclosure.

If there is no special description, the raw materials used in the examples of the present disclosure are all commercially available or available to those skilled in the art, and if there is no special description, the methods used in the examples are all methods mastered by those skilled in the art.

If there is no special description, the copper-antimony alloy used in the present disclosure is commercially available 300-mesh copper-antimony alloy with purity of 2N.

If there is no special description, since the crude arsenic-containing antimony chloride solution to be treated used in the present disclosure has many sources and different batches, the arsenic content and the antimony content in the crude antimony chloride solution to be treated need to be characterized before each experiment so as to calculate an arsenic removal rate and an antimony loss rate.

### Examples 1-6

A method for purifying an antimony chloride solution through arsenic removal is provided.

The method includes:
1) Copper-antimony alloy is added into a crude arsenic-containing antimony chloride solution to be treated in a protective atmosphere to obtain an antimony chloride solution containing low-concentration arsenic impurities after a reaction.
2) Distillation and concentration are performed on the antimony chloride solution containing low-concentration arsenic impurities at 160° C., automatic sampling characterization is performed on distilled gas every 5 min, such that a distilled gas sample makes contact with a heat source, a temperature of the heat source is controlled to be ≥250° C., and distillation is terminated when the distilled gas sample makes contact with the heat source without producing an arsenic mirror, thereby obtaining a high-purity antimony chloride solution.

The high-purity antimony chloride solution is distilled at 225° C. and condensed and crystallized at a room temperature to obtain a high-purity antimony chloride product (SbCl₃ molten salt).

Reaction parameters of various groups in an arsenic removal process of copper-antimony alloy is shown in the table below.

| | | Stoichio- | | HCl | Stirring | Reac- |
|---|---|---|---|---|---|---|
| | Copper | metric | Temper- | concen- | rotation | tion |
| | content | ratio | ature | tration | speed | time |
| Example 1 | 80 wt % | 16 | 90° C. | 6 mol/L | 400 rpm | 120 min |
| Example 2 | 80 wt % | 8 | 90° C. | 6 mol/L | 400 rpm | 120 min |
| Example 3 | 80 wt % | 28 | 90° C. | 6 mol/L | 400 rpm | 120 min |
| Example 4 | 80 wt % | 16 | 90° C. | 8 mol/L | 400 rpm | 120 min |
| Example 5 | 80 wt % | 16 | 90° C. | 6 mol/L | 100 rpm | 120 min |
| Example 6 | 80 wt % | 16 | 90° C. | 6 mol/L | 400 rpm | 60 min |

In the table, the copper content is the copper content in the copper-antimony alloy, and the stoichiometric ratio is the stoichiometric ratio of the copper content in the copper-antimony alloy to the arsenic content in the crude arsenic-containing antimony chloride solution to be treated. The temperature is the reaction temperature of step 1), and the HCl concentration is the hydrogen chloride concentration in the crude antimony chloride solution to be treated in step 1). The stirring rotation speed is the stirring rotation speed controlled in the reaction process of step 1), and the reaction time is a reaction duration of step 1).

The arsenic content, the arsenic removal rate and the antimony loss rate in the treated high-purity antimony chloride solution are characterized and calculated, and the following results are obtained.

| | Exam- | Exam- | Exam- | Exam- | Exam- | Exam- |
|---|---|---|---|---|---|---|
| | ple 1 | ple 2 | ple 3 | ple 4 | ple 5 | ple 6 |
| Arsenic | 38.4 | 155 | 2.37 | 3.47 | 40.2 | 52.7 |
| content (ppm) | | | | | | |
| Arsenic | 91.6% | 65.9% | 99.2% | 90.1% | 91.2% | 88.4% |
| removal rate | | | | | | |
| Antimony loss | 5.8% | 4.9% | 8.7% | 6.3% | 5.7% | 5.8% |
| rate | | | | | | |

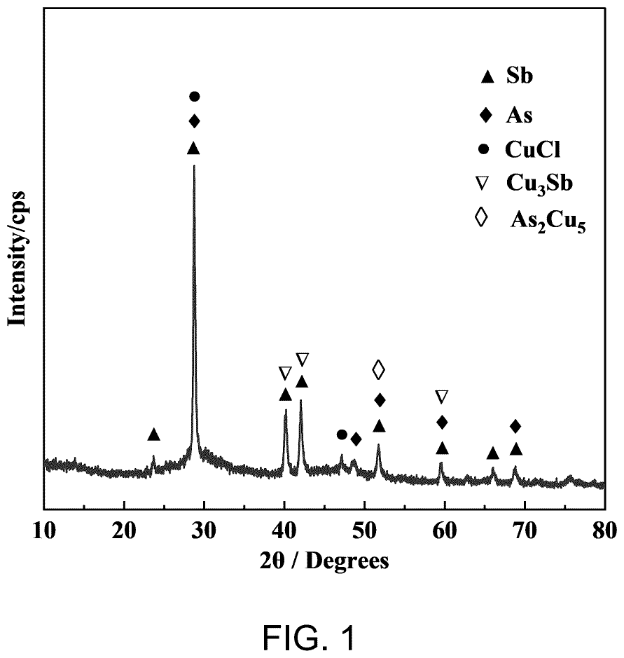

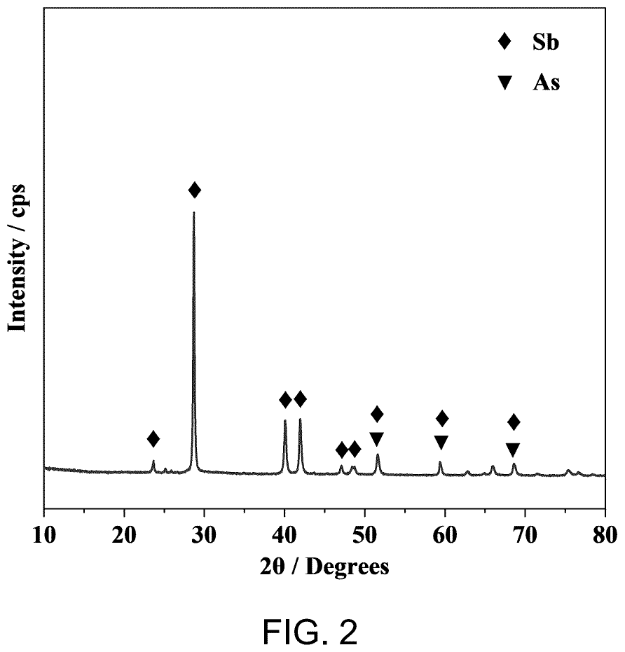

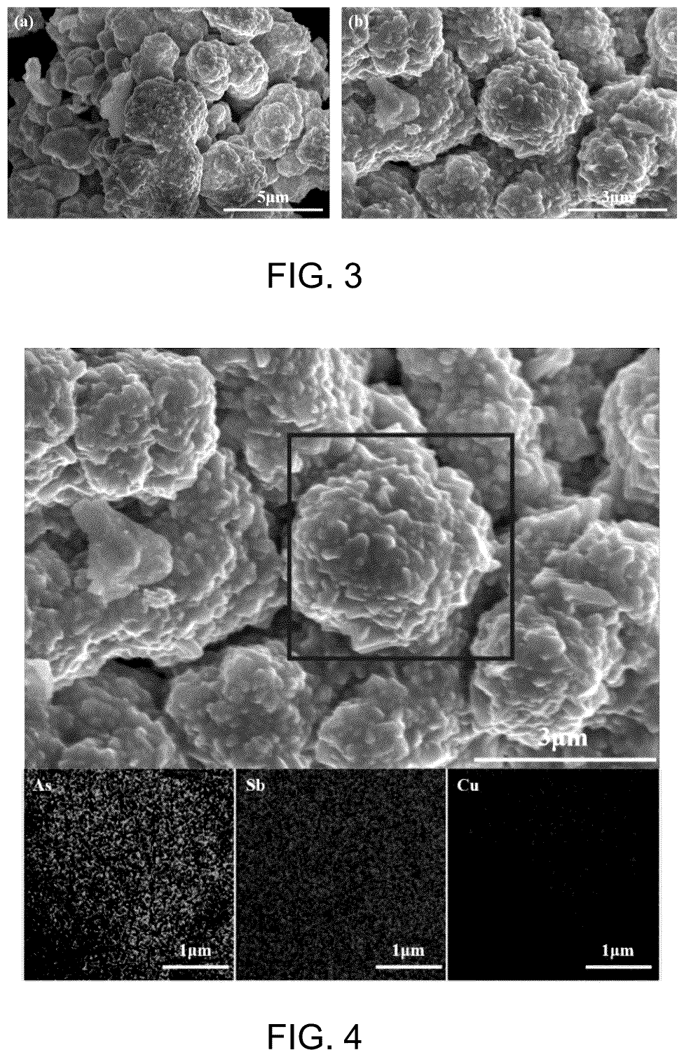

In examples 1-6, various tests are performed on filter cakes obtained through filtration and separation after completion of the displacement reaction in step 1) and condensed crystal products. FIG. 1 shows X-ray diffraction (XRD) testing results of a filter cake in Example 1, and FIG. 2 shows XRD testing results of a product in Example 2. It can be clearly seen that the stoichiometric ratio of the copper and the arsenic in the copper-antimony alloy powder affects the replacement process and the arsenic removal efficiency. When the stoichiometric ratio of the copper and the arsenic is low, replacement products at the end of the reaction are mainly elementary arsenic and antimony. When the stoichiometric ratio of the copper and the arsenic is increased, side reactions occur in the solution to form arsenic copper intermetallic compounds Cu₂Sb and As₂Cu₅ besides the elementary antimony and arsenic. Occurrence of the side reactions greatly improve the removal efficiency of the arsenic from the antimony chloride solution. As shown in a scanning electron microscopy (SEM) image of FIG. 3, the structure of the replacement reaction product is composed of spherical particles of different sizes, and this structure is the key to complete removal of arsenic from the antimony chloride solution. It is worth noting that the hydrochloric acid concentration also plays an important role in arsenic removal efficiency, and hydrochloric acid enhances and promotes the side reactions. FIG. 4 shows energy disperse spectroscopy (EDS) analysis of the surface structure of the product of Example 1. EDS analysis results show that intermetallic compounds of copper and arsenic are formed on the surfaces of the spherical particles. Therefore, arsenic removal from the solution can be divided into two parts, namely the elementary arsenic generated in the replacement main reaction, and the intermetallic compounds of copper and arsenic generated in the side reactions, so as to achieve the purpose of efficient arsenic removal.

SbCl₃ molten salt products obtained in all examples are characterized, and characterization results are shown in the table below.

| | Exam- | Exam- | Exam- | Exam- | Exam- | Exam- |
|---|---|---|---|---|---|---|
| | ple 1 | ple 2 | ple 3 | ple 4 | ple 5 | ple 6 |
| Arsenic | 11.5 | 50.6 | 0.61 | 1.22 | 14.3 | 17.9 |
| content (ppm) | | | | | | |
| Purity level | 3N | 3N | 5N | 4N | 4N | 3N |

It can be clearly seen from the above characterization results that the high-purity antimony chloride molten salt obtained in the present disclosure can stably reach the purity level of 3N.

### Comparative Example 1

The same experimental operation is carried out based on the experimental group of Example 3, except that experiments are carried out using different copper-antimony alloy. Experimental results are shown in the following table.

| | Copper content (wt %) | | | | | |
|---|---|---|---|---|---|---|
| | 60 | 70 | 80 | 90 | 95 | 99.9 |
| Arsenic content | 97.4 | 76.2 | 2.37 | 10.6 | 16.6 | 2.21 |
| (ppm) | | | | | | |
| Arsenic | 52.6% | 87.9% | 99.2% | 96.1% | 97.7% | 99.4% |
| removal rate | | | | | | |
| Antimony loss | 2.1% | 4.9% | 8.7% | 9.3% | 9.7% | 22.8% |
| rate | | | | | | |

In the table, the copper content is the copper content in the copper-antimony alloy.

From the above results, it can be seen that with the increase of the copper content, the arsenic removal rate generally presents an upward trend, but the antimony loss rate also presents a great upward trend. When the copper content is 60 wt % (the balance antimony and inevitable impurities, about 40 wt % of antimony content), the arsenic removal rate is extremely low. It can be seen that in the technical solution of the present disclosure, antimony loss still needs to be considered for an arsenic removal effect and an actual industrial implementation effect, and the copper content of the optimal copper-antimony alloy should be controlled to be 70-95 wt %.

### Comparative Example 2

The same experimental operation is carried out based on the experimental group of Example 3, except that experiments are carried out by adjusting the concentration of hydrogen chloride in the crude arsenic-containing antimony chloride solution to be treated. Experimental results are shown in the following table.

| | HCl concentration (mol) | | | | | |
|---|---|---|---|---|---|---|
| | 2 | 3 | 6 | 8 | 10 | 12 |
| Arsenic content | 63.6 | 51.2 | 2.37 | 6.93 | 16.2 | 10.8 |
| (ppm) | | | | | | |
| Arsenic | 89.13% | 93.6% | 99.2% | 98.6% | 71.6% | 81.7% |
| removal rate | | | | | | |

In the table: the HCl concentration refers to a hydrogen chloride concentration in the crude arsenic-containing antimony chloride solution to be treated in step 1).

From the above results, it can be clearly seen that considering the influence of the original arsenic content in the actual solution to be treated, the arsenic removal rate of the present disclosure is generally increased at first and then is decreased with the increase of the hydrogen chloride concentration, especially when the HCl concentration reaches 10 mol/L, the arsenic removal rate is decreased in a cliff-like manner, which is mainly due to the influence of the HCl concentration on the existing form of the arsenic element in the solution to be treated, and AsO⁺ ions are the most suitable existing form of the arsenic element removed in the technical solution of the present disclosure, which has a great impact on the actual solution effect. Therefore, technicians believe that the hydrogen chloride concentration should be controlled at 3-8 mol/L.

### Example 7

The same experimental operation is carried out based on the experimental group of Example 1, except that the high-purity antimony chloride solution is distilled at 225° C., then is condensed at 175° C. and is recovered to obtain liquid antimony chloride, and the liquid antimony chloride is cooled and crystallized at a room temperature to be recovered to obtain a high-purity antimony chloride product (SbCl₃ molten salt).

Five groups of different solutions to be treated are divided into equal parts and treated according to the solution of Example 1 and the solution of this example respectively. The arsenic content and purity of the products of SbCl₃ molten salt obtained in this example and Example 1 are characterized, and results are shown in the table below.

| | Result 1 | Result 2 | Result 3 | Result 4 | Result 5 |
|---|---|---|---|---|---|
| Example 1 | | | | | |
| Arsenic content | 10.6 | 1.83 | 13.2 | 10.1 | 11.9 |
| (ppm) | | | | | |
| Purity level | 3N | 4N | 3N | 3N | 3N |
| Example 7 | | | | | |
| Arsenic content | 1.62 | 0.81 | 1.86 | 1.22 | 1.35 |
| (ppm) | | | | | |
| Purity level | 4N | 5N | 4N | 4N | 4N |

In the table, the same column represents the same test group of the solution to be treated.

It can be seen from the above characterization results that the purity of the product can be further significantly improved through fractional cooling recovery, mainly because a small part of arsenic impurities that cannot be removed in the distillation concentration process due to intermolecular interaction can be further removed in the fractional cooling recovery process.

What is claimed is:

1. A method for purifying an antimony chloride solution through arsenic removal, comprising:
1) adding copper-antimony alloy into a crude arsenic-containing antimony chloride solution to be treated in a protective atmosphere to obtain an antimony chloride solution containing low-concentration arsenic impurities after a reaction for arsenic removal; and
2) performing distillation and concentration on the antimony chloride solution containing low-concentration arsenic impurities to obtain a high-purity antimony chloride solution.

2. The method for purifying an antimony chloride solution through arsenic removal according to claim 1, wherein
the protective atmosphere in step 1) is a nitrogen atmosphere, and nitrogen is continuously introduced into the solution system during the reaction process in step 1).

3. The method for purifying an antimony chloride solution through arsenic removal according to claim 1, wherein
a temperature of the reaction for arsenic removal in step 1) is controlled to be 30-90° C.; and
stirring is performed in the reaction for arsenic removal, a stirring rotation speed is controlled to be 100-500 rpm, and a time of the reaction for arsenic removal is 30-120 min.

4. The method for purifying an antimony chloride solution through arsenic removal according to claim 1, wherein
a stoichiometric ratio of a copper content in the copper-antimony alloy to an arsenic content in the crude arsenic-containing antimony chloride solution to be treated in step 1) is (10-40):1.

5. The method for purifying an antimony chloride solution through arsenic removal according to claim 1, wherein
a distillation temperature for the distillation and concentration in step 2) is controlled to be 160-180° C.

6. The method for purifying an antimony chloride solution through arsenic removal according to claim 1, wherein
a distilled gas sample obtained in the distillation and concentration in step 2) makes contact with a heat source, a temperature of the heat source is controlled to be ≥250° C., and the distillation is terminated when the distilled gas sample makes contact with the heat source without producing an arsenic mirror.

7. The method for purifying an antimony chloride solution through arsenic removal according to claim 1, wherein
the high-purity antimony chloride solution obtained after the distillation and concentration in step 2) is subjected to secondary distillation and condensation to obtain high-purity antimony chloride.

8. The method for purifying an antimony chloride solution through arsenic removal according to claim 7, wherein
a distillation temperature for the secondary distillation is controlled to be 220-240° C.

9. The method for purifying an antimony chloride solution through arsenic removal according to claim 7, wherein
two-stage recovery is carried out in the condensation, firstly, recovering is performed at 160-180° C. to obtain liquid antimony chloride, and then, the liquid antimony chloride is cooled to reach a recovery temperature of ≤70° C., thereby obtaining high-purity antimony chloride.

10. The method for purifying an antimony chloride solution through arsenic removal according to claim 5, wherein
a distilled gas sample obtained in the distillation and concentration in step 2) makes contact with a heat source, a temperature of the heat source is controlled to be ≥250° C., and the distillation is terminated when the distilled gas sample makes contact with the heat source without producing an arsenic mirror.

11. The method for purifying an antimony chloride solution through arsenic removal according to claim 8, wherein
two-stage recovery is carried out in the condensation, firstly, recovering is performed at 160-180° C. to obtain liquid antimony chloride, and then, the liquid antimony chloride is cooled to reach a recovery temperature of ≤70° C., thereby obtaining high-purity antimony chloride.
